(19) United States
(12) Patent Application Publication
(10) Pub. No.: US 2013/0171956 A1
(43) Pub. Date: Jul. 4, 2013

(54) MAN-OVERBOARD RADIO

(71) Applicant: Michael Maurice Lever, Vancouver (CA)

(72) Inventor: Michael Maurice Lever, Vancouver (CA)

(21) Appl. No.: 13/732,665

(22) Filed: Jan. 2, 2013

Related U.S. Application Data
(60) Provisional application No. 61/582,511, filed on Jan. 3, 2012.

(51) Int. Cl. H04W 4/22

(52) U.S. Cl. 455/404.1

(57) ABSTRACT

A wireless device is provided, comprising: a body; a transmitter and a receiver mounted in the body and adapted for at least two-way wireless voice and data communications; a sensor mounted in a container formed on or within the body, the sensor generating a signal when liquid entering the container accumulates to a predetermined level or volume; and, a processor adapted to receive the signal and to control the transmitter to transmit an alarm message indicative of the signal.

### RELATED APPLICATION

This application is a U.S. non-provisional application, claiming priority from U.S. provisional patent application Ser. No. 61/582,511 filed on Jan. 3, 2012.

### FIELD OF THE DISCLOSURE

This disclosure relates to the field of wireless devices and man-overboard alarm systems, and more specifically, to a wireless device for aquatic use having man-overboard alarm functionality.

### BACKGROUND

Current radios and wireless mobile communication devices for outdoor and aquatic use may include microprocessors, memory, speakers, headphones, and may run one or more software applications in addition to providing for voice communications. Such wireless devices may be used by skiers, mountain climbers, hikers, bikers, sailors, fishers, hunters, swimmers, scuba divers, kayakers, boaters, firefighters, police, military, coast guard, merchant mariners, etc.

In addition, current man-overboard alarm systems are available which include stand-alone wireless devices in radio communication with a central monitoring station. These systems provide an alarm at the central monitoring station when, for example, a fisher wearing the wireless device is swept over the side of his or her fishing boat and into the water.

In another example, a scuba diver may use a radio while on the surface of the water to contact his or her dive boat. The effective use and operation of such radios is essential for maintaining diver safety in emergency situations. In particular, in emergency situations where the dive boat is not available to retrieve a diver or has left the dive area, it is essential for maintaining diver safety that effective distress communications are available to the diver in order to contact the dive boat so that the diver may be retrieved. In most instances a wayward dive boat may be recalled via surface communication to the dive area to retrieve the abandoned diver. A diver who is left behind at the dive area will realize his or her problem while on the surface of the water and will need to communicate with boats or others who are at or above the surface of the water in order to affect his or her rescue. Divers being left behind by dive boats is a big problem. In fact, an estimated 30 to 45 divers get left behind by dive boats or are otherwise lost at sea and consequently die every year. Similarly, a commercial fisher working at sea may be swept over the side of his or her fishing boat during a winter storm. Such a situation may prove fatal unless the fisher can contact the fishing boat to be retrieved.

Existing radios and wireless devices for such users are problematic. Some existing devices include Global Positioning System (“GPS”) based locating equipment; however, these devices are typically quite expensive and are cumbersome for use in an emergency situation. Other radios are not sufficiently waterproofed in order to provide adequate protection from the elements. In addition, existing man-overboard alarm systems do not allow for voice communications between a user equipped with a man-overboard wireless device and a central station. Furthermore, existing wireless man-overboard devices are prone to generating false alarms when exposed to the elements while a user is on deck and not overboard.

A need therefore exists for an improved wireless device for aquatic use having man-overboard alarm functionality. Accordingly, a solution that addresses, at least in part, the above and other shortcomings is desired.

### SUMMARY OF THE DISCLOSURE

According to one aspect of the disclosure, there is provided a wireless device, comprising: a body; a transmitter and a receiver mounted in the body and adapted for at least two-way wireless voice and data communications; a sensor mounted in a container formed on or within the body, the sensor generating a signal when liquid entering the container accumulates to a predetermined level or volume; and, a processor adapted to receive the signal and to control the transmitter to transmit an alarm message indicative of the signal.

### BRIEF DESCRIPTION OF DRAWINGS

Features and advantages of the embodiments of the present disclosure will become apparent from the following detailed description, taken in combination with the appended drawings, in which:

FIG. 1 is a right side view illustrating a wireless device having a front mounted water intake grill and a front mounted water pressure sensor and with its sensor cover removed in accordance with an embodiment of the disclosure;

FIG. 2 is a front view thereof;

FIG. 3 is a right side view illustrating a wireless device having a front mounted water intake grill and a front mounted water level sensor and with its sensor cover removed in accordance with an embodiment of the disclosure;

FIG. 4 is a front view thereof;

FIG. 5 is a right side view illustrating a wireless device having a rear mounted water intake grill and a rear mounted water level sensor and with its sensor cover removed in accordance with an embodiment of the disclosure;

FIG. 6 is a rear view thereof;

FIG. 7 is a right side view illustrating a wireless device having a rear mounted water intake grill and a rear mounted water pressure sensor and with its sensor cover removed in accordance with an embodiment of the disclosure;

FIG. 8 is a rear view thereof;

FIG. 9 is a top view of illustrating a wireless device having a single water intake valve and a front mounted water pressure sensor in accordance with an embodiment of the disclosure;

FIG. 10 is a front view thereof;

FIG. 11 is a right side view thereof;

FIG. 12 is a first cross sectional view thereof;

FIG. 13 is a second cross sectional view thereof;

FIG. 14 is a top view of illustrating a wireless device having a single water intake valve and a rear mounted water pressure sensor in accordance with an embodiment of the disclosure;

FIG. 15 is a rear view thereof;

FIG. 16 is a right side view thereof;

FIG. 17 is a first cross sectional view thereof;

FIG. 18 is a second cross sectional view thereof;

FIG. 19 is a top view of illustrating a wireless device having first and second water intake valves and front and rear mounted water pressure sensors in accordance with an embodiment of the disclosure;

FIG. 20 is a front view thereof;

FIG. 21 is a rear view thereof;

FIG. 22 is a right side view thereof;

FIG. 23 is a right side view illustrating a wireless device having a front mounted water intake flap and a front mounted water pressure sensor and with its sensor cover removed in accordance with an embodiment of the disclosure;

FIG. 24 is a front view thereof;

FIG. 25 is a right side view illustrating a wireless having a front mounted water intake flap and a front mounted water level sensor and with its sensor cover removed in accordance with an embodiment of the disclosure;

FIG. 26 is a front view thereof;

FIG. 27 is a right side view illustrating a wireless device having a rear mounted water intake flap and a rear mounted water pressure sensor and with its sensor cover removed in accordance with an embodiment of the disclosure;

FIG. 28 is a rear view thereof;

FIG. 29 is a right side view illustrating a wireless device having a rear mounted water intake flap and a rear mounted water level sensor and with its sensor cover removed in accordance with an embodiment of the disclosure;

FIG. 30 is a rear view thereof;

FIG. 31 is a rear perspective view illustrating the wireless device of FIGS. 5-8 with its sensor cover installed in accordance with an embodiment of the disclosure;

FIG. 32 is a rear perspective view illustrating the wireless device of FIG. 27-30 with its sensor cover installed in accordance with an embodiment of the disclosure; and,

FIG. 33 is a block diagram illustrating the wireless device of FIGS. 1-32 in accordance with an embodiment of the disclosure.

It will be noted that throughout the appended drawings, like features are identified by like reference numerals.

### DETAILED DESCRIPTION OF EMBODIMENTS

In the following description, details are set forth to provide an understanding of the disclosure. In some instances, certain software, circuits, structures and techniques have not been described or shown in detail in order not to obscure the disclosure.

According to one embodiment, the disclosure provides a wireless device having one or more water sensors and a radio for operation on multiple frequencies (e.g., VHF (very high frequency), marine band VHF, wireless network frequencies, Wi-Fi frequencies, wireless local area network (WLAN) frequencies, cellular telephone frequencies, BlueTooth™ frequencies, etc.). The housing of the wireless device may be waterproofed. The wireless device may be used in order to detect when a user goes overboard and to help prevent the user from getting lost or left behind while outdoors or at sea. The wireless device may also be used both outdoors and indoors (e.g., around swimming pools, etc.). The wireless device may be equipped with a GPS display, an imbedded dive computer, a tone generator to transmit GPS information, an emergency distress or call button, etc.

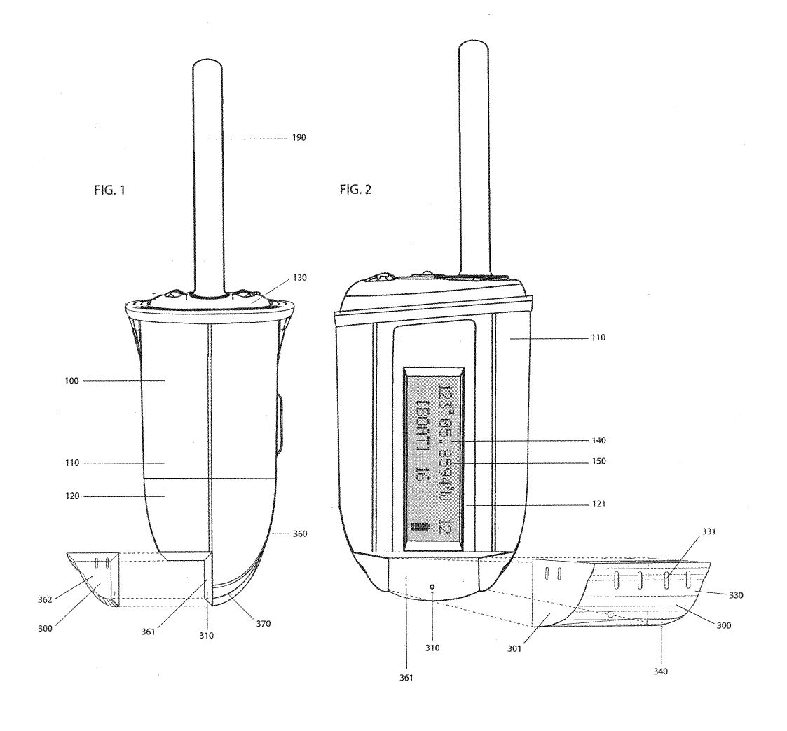

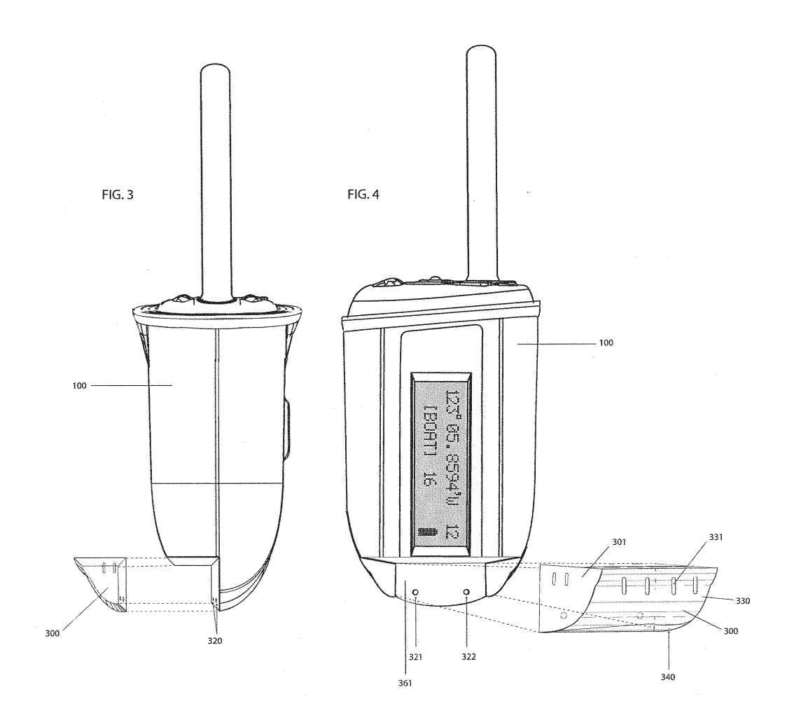

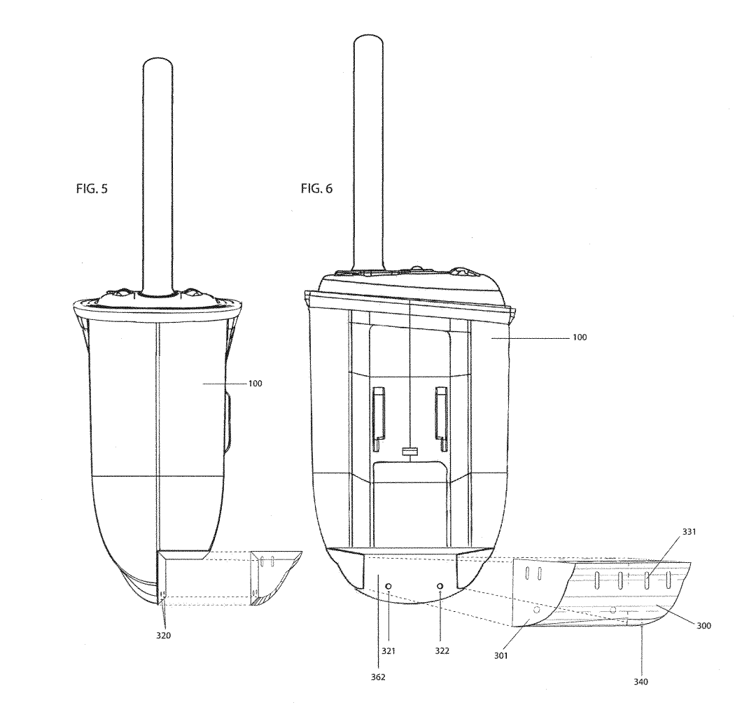

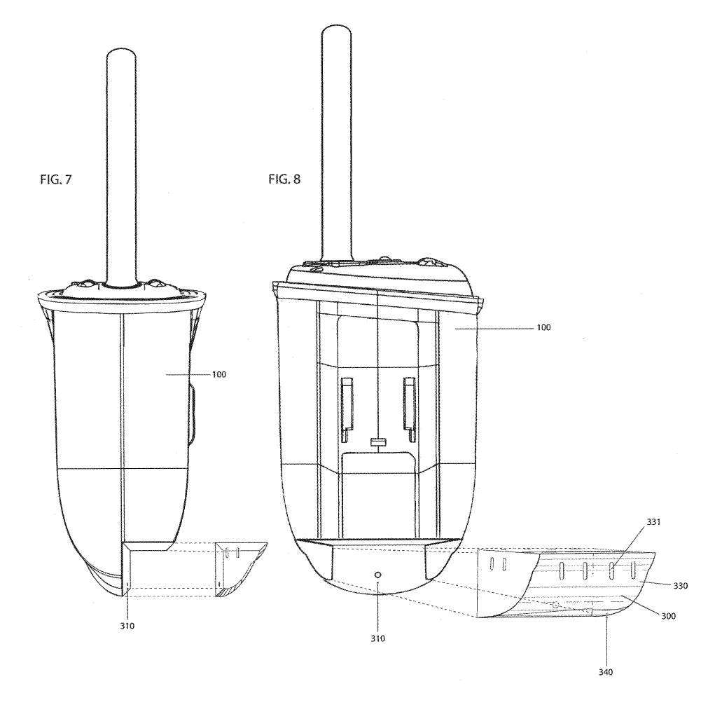

FIG. 1 is a right side view illustrating a wireless device 100 having a front mounted water intake grill 330 and a front mounted water pressure sensor 310 and with its sensor cover 300 removed in accordance with an embodiment of the disclosure. FIG. 2 is a front view thereof. FIG. 3 is a right side view illustrating a wireless device 100 having a front mounted water intake grill 330 and a front mounted water level sensor 320 and with its sensor cover 300 removed in accordance with an embodiment of the disclosure. FIG. 4 is a front view thereof. FIG. 5 is a right side view illustrating a wireless device 100 having a rear mounted water intake grill 330 and a rear mounted water level sensor 320 and with its sensor cover 300 removed in accordance with an embodiment of the disclosure. FIG. 6 is a rear view thereof. FIG. 7 is a right side view illustrating a wireless device 100 having a rear mounted water intake grill 330 and a rear mounted water pressure sensor 310 and with its sensor cover 300 removed in accordance with an embodiment of the disclosure. FIG. 8 is a rear view thereof. And, FIG. 31 is a rear perspective view illustrating the wireless device 100 of FIGS. 5-8 with its sensor cover 300 installed in accordance with an embodiment of the disclosure.

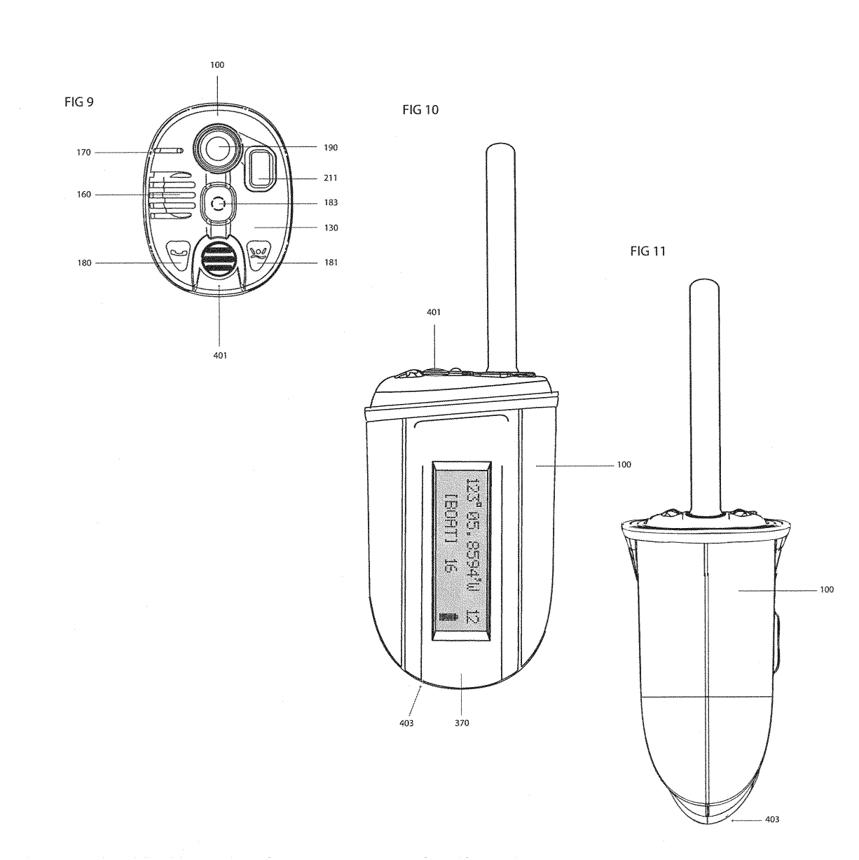

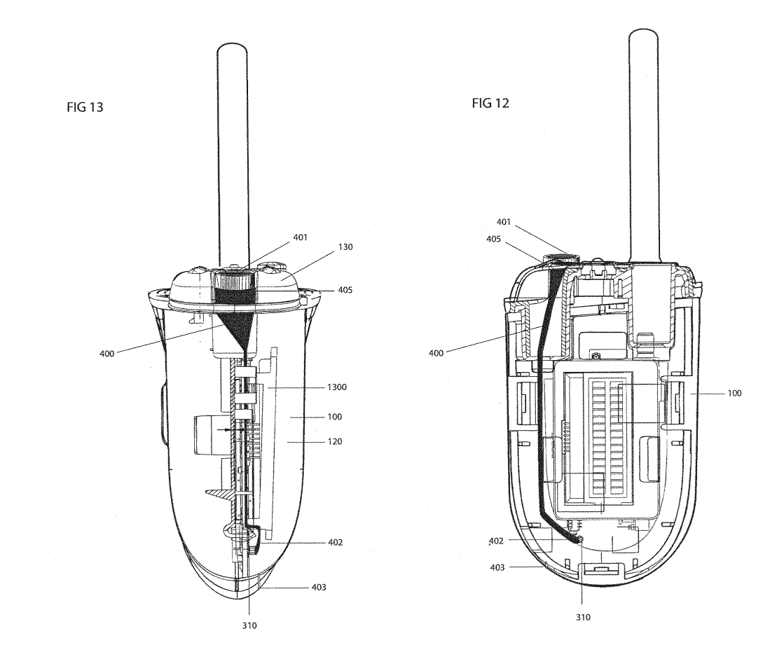

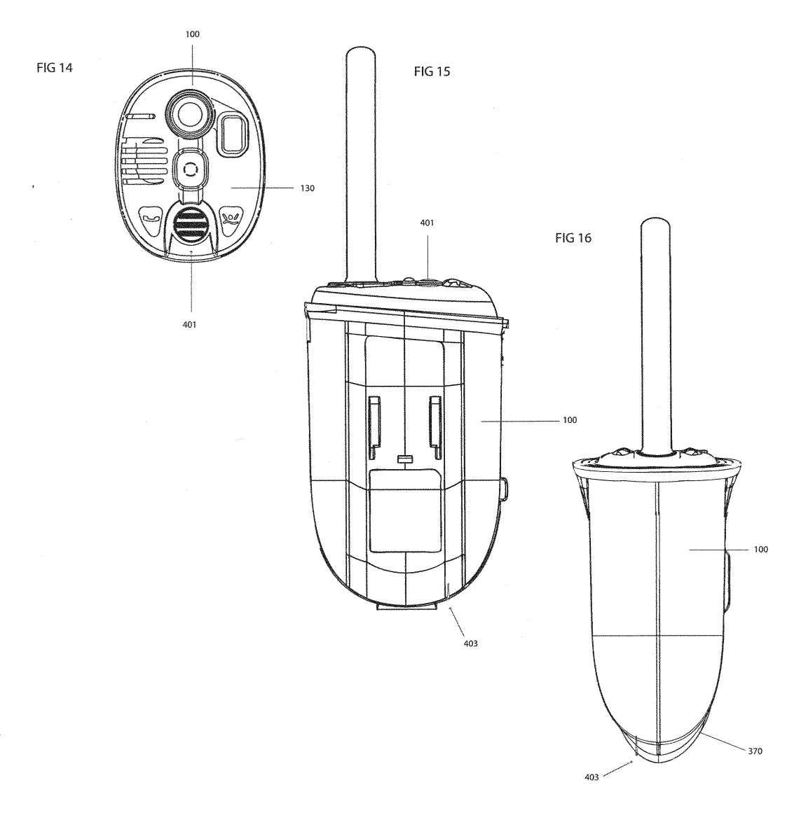

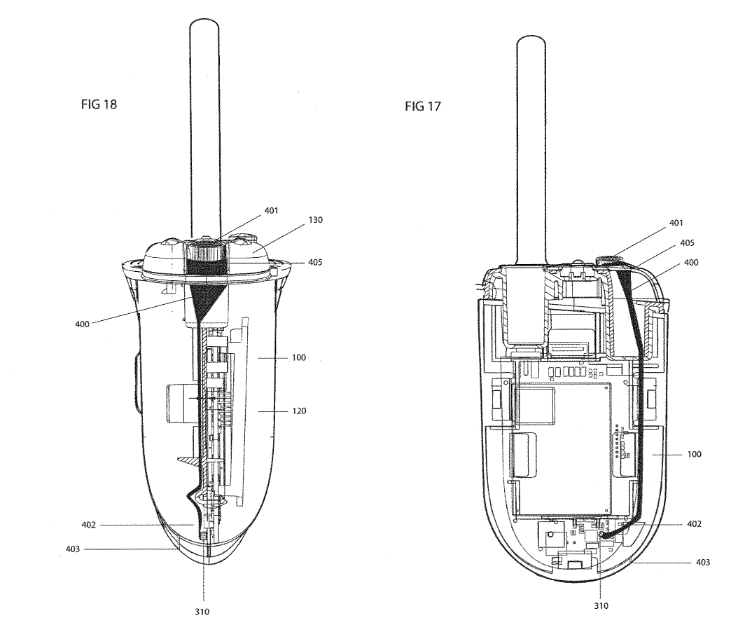

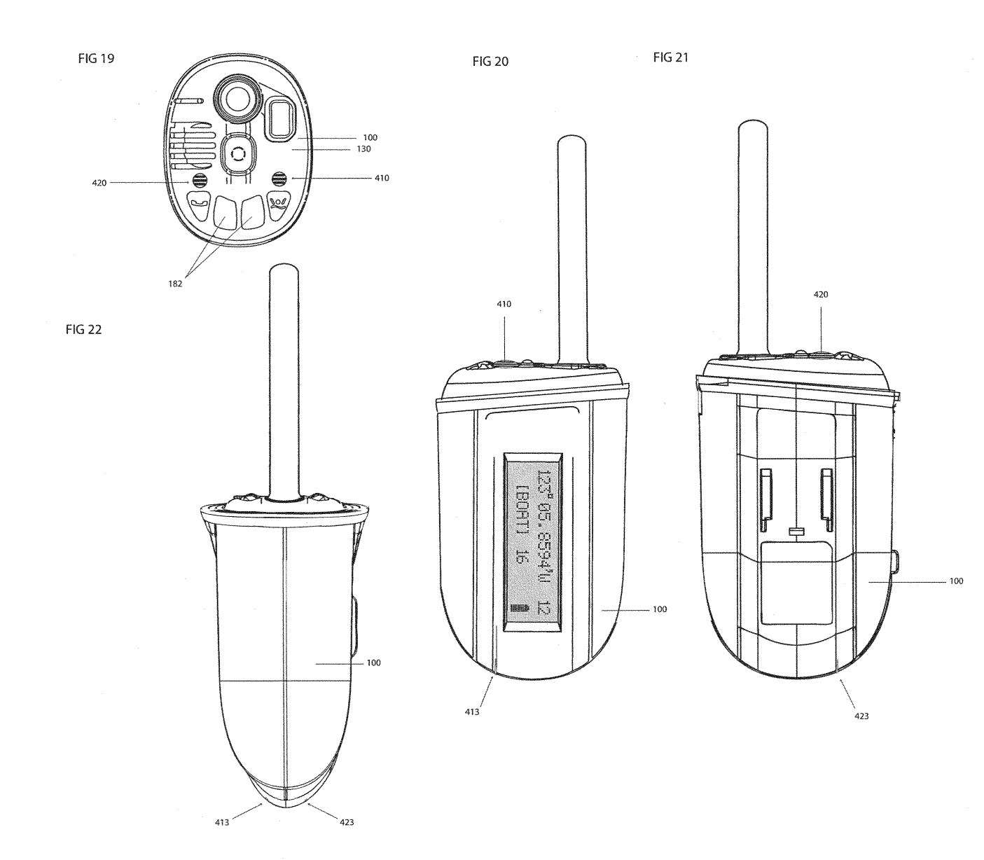

FIG. 9 is a top view of illustrating a wireless device 100 having a single water intake valve 400 and a front mounted water pressure sensor 310 in accordance with an embodiment of the disclosure. FIG. 10 is a front view thereof. FIG. 11 is a right side view thereof. FIG. 12 is a first cross sectional view thereof. FIG. 13 is a second cross sectional view thereof. FIG. 14 is a top view of illustrating a wireless device 100 having a single water intake valve 400 and a rear mounted water pressure sensor 310 in accordance with an embodiment of the disclosure. FIG. 15 is a rear view thereof. FIG. 16 is a right side view thereof. FIG. 17 is a first cross sectional view thereof. FIG. 18 is a second cross sectional view thereof. FIG. 19 is a top view of illustrating a wireless device 100 having first and second water intake valves 410, 420 and front and rear mounted water pressure sensors 310, 311 in accordance with an embodiment of the disclosure. FIG. 20 is a front view thereof. FIG. 21 is a rear view thereof. And, FIG. 22 is a right side view thereof.

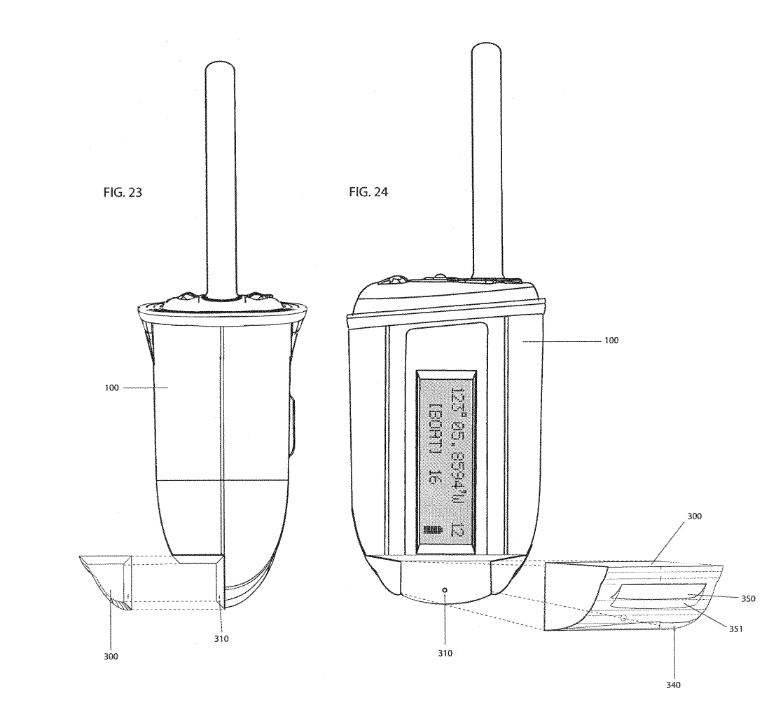

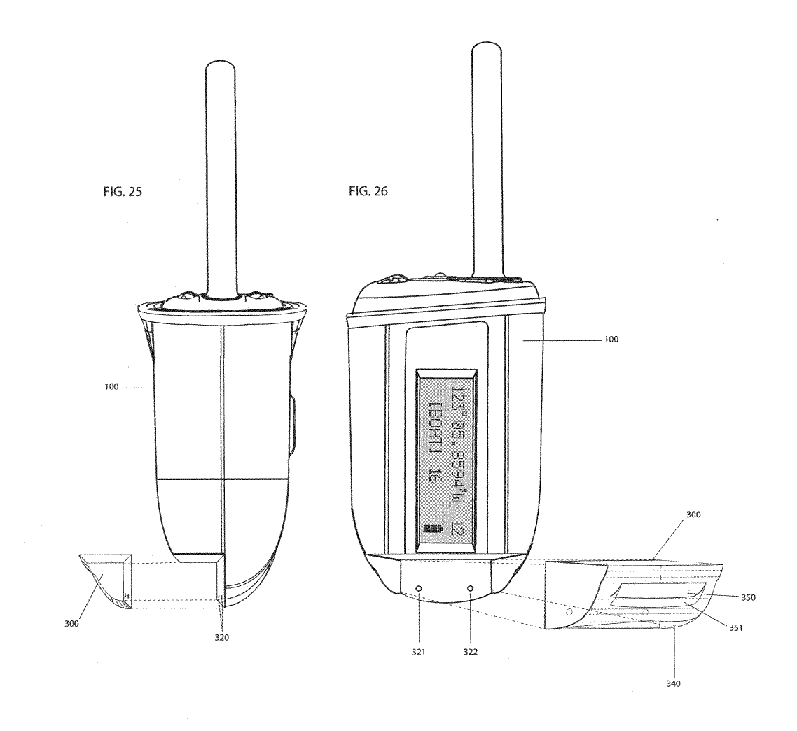

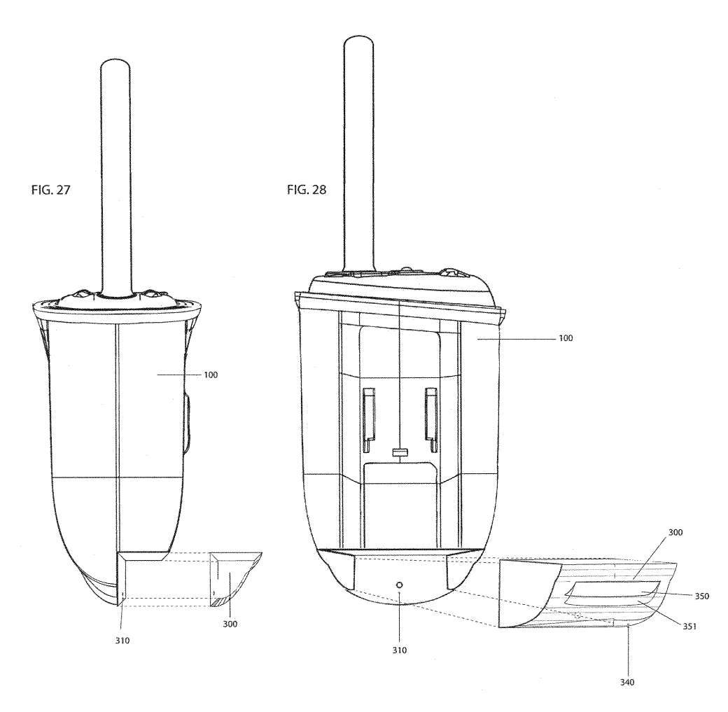

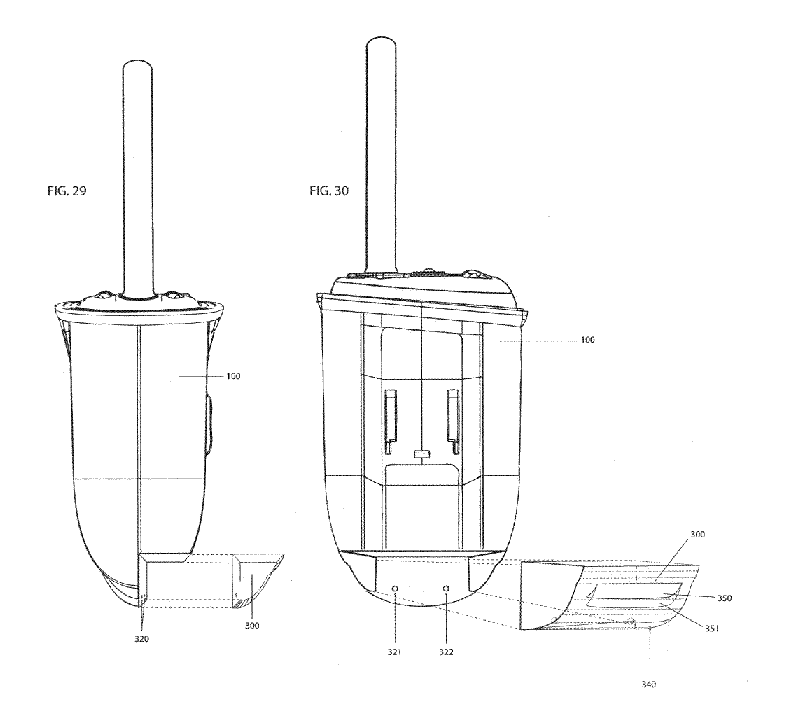

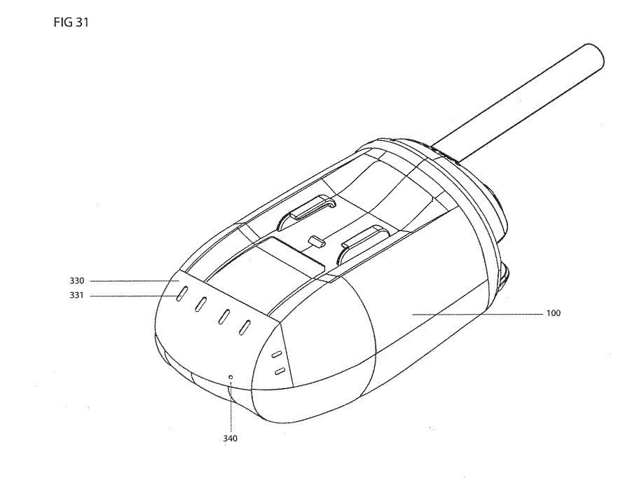

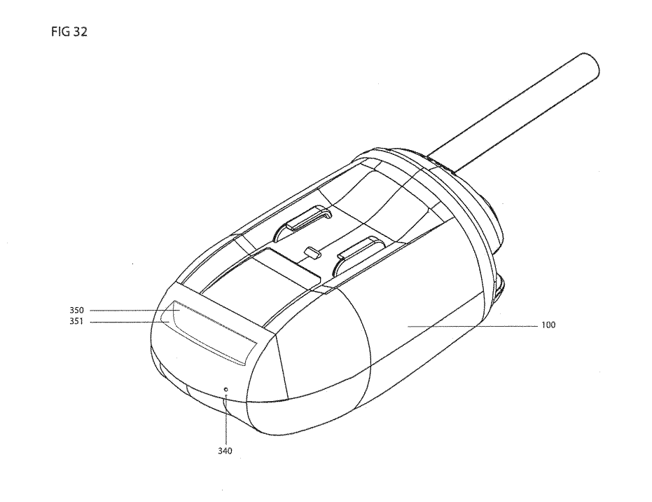

FIG. 23 is a right side view illustrating a wireless device 100 having a front mounted water intake flap 350 and a front mounted water pressure sensor 310 and with its sensor cover 300 removed in accordance with an embodiment of the disclosure. FIG. 24 is a front view thereof. FIG. 25 is a right side view illustrating a wireless device 100 having a front mounted water intake flap 350 and a mounted water level sensor 320 and with its sensor cover 300 removed in accordance with an embodiment of the disclosure. FIG. 26 is a front view thereof. FIG. 27 is a right side view illustrating a wireless device 100 having a rear mounted water intake flap 350 and a rear mounted water pressure sensor 310 and with its sensor cover 300 removed in accordance with an embodiment of the disclosure. FIG. 28 is a rear view thereof. FIG. 29 is a right side view illustrating a wireless device 100 having a rear mounted water intake flap 350 and a rear mounted water level sensor 320 and with its sensor cover 300 removed in accordance with an embodiment of the disclosure. FIG. 30 is a rear view thereof. And, FIG. 32 is a rear perspective view illustrating the wireless device 100 of FIG. 27-30 with its sensor cover 300 installed in accordance with an embodiment of the disclosure.

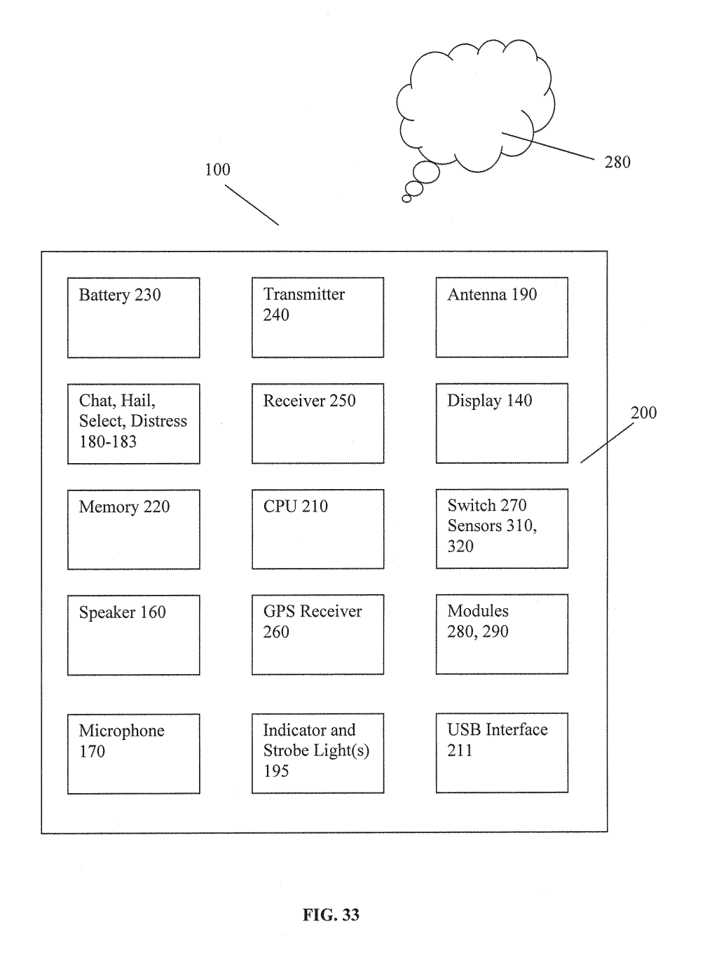

FIG. 33 is a block diagram illustrating the wireless device 100 of FIGS. 1-32 in accordance with an embodiment of the disclosure.

According to one embodiment, the wireless device 100 includes an enclosure 110 having a body 120 and a lid 130, a display (e.g., a liquid crystal display (“LCD”)) 140, a graphical user interface (“GUI”) 150 displayed on the display 140, a speaker 160 (e.g., an electromechanical speaker), a microphone 170 (e.g., an electret microphone), an antenna 190, an universal serial bus (“USB”) interface or port 211 for transmitting and receiving information and settings to and from external devices and for charging the battery 230, a chat (non-emergency) push-to-talk button 180, a hailing (emergency) push-to-talk button 181, select/scroll button(s) 182, and a distress (e.g., a Digital Selective Calling (“DSC”) or an Automatic Identification System (“AIS”)) button 183. Internally, the wireless device 100 may include one or more circuit boards 1300 for mounting components, a microprocessor (or central processing unit (“CPU”)) 210 which controls overall operation of the wireless device 100, memory 220, a battery 230 (e.g., a Lithium ion battery), a transmitter 240 (e.g., a VHF transmitter, cellular transmitter, Wi-Fi transmitter, etc.), a receiver 250 (e.g., a VHF receiver, cellular receiver, Wi-Fi receiver, etc.), and a Global Positioning System (“GPS”) receiver 260 (e.g., an L1 Band GPS receiver) which are operatively coupled to the display 140, the speaker 160, the microphone 170, the antenna 190, the chat, hailing, select/scroll, and distress buttons 180, 181, 182, 183, an on/off switch 270, and one or more water pressure and water level sensors 310, 320 as will be described below.

The wireless device 100 may operate over a wireless network 280. The wireless network 280 may include antenna, base stations, access points, transceivers, supporting radio equipment, etc., as known to those of ordinary skill in the art, for supporting wireless communications between the wireless device 100 and other devices (not shown).

The wireless device 100 may be a two-way communication device having at least voice and data communication capabilities, including the capability to communicate with other devices. Depending on the functionality provided by the wireless device 100, it may be referred to as a radio, a rescue radio, a man-overboard radio, a wireless device, a data messaging device, a cellular telephone with data messaging capabilities, a data communication device (with or without telephony capabilities), or a portable or handheld radio device. The wireless device 100 may communicate with any one of a plurality of transceiver stations (not shown) within its geographic coverage area.

The wireless device 100 includes computer executable programmed instructions for directing the device 100 to implement the embodiments of the present disclosure. The programmed instructions may be embodied in one or more hardware modules 280 or software modules 290 resident in the memory 220 of the device 100 or elsewhere (e.g., 210).

The microprocessor 210 is coupled to the memory 220. The memory 220 has various hardware and software components for storing information (e.g., instructions, data, database tables, test parameters, etc.) for enabling operation of the wireless device 100. In order to provide a user-friendly environment to control the operation of the wireless device 100, operating system software modules 290 resident on the wireless device 100 may provide a basic set of operations for supporting various applications which may be operable through the GUI 150 and supporting GUI software modules 290. The wireless device 100 may be provided with additional hardware 280 and/or software modules 290 for facilitating and implementing various functions.

According to one embodiment, the microphone 170 is located adjacent to the speaker 160. The microphone 170 and speaker 160 may be protected from the elements by a rubber membrane which may be included in or form the lid 130. The microphone 170 and speaker 160 may be waterproof devices.

According to one embodiment, the components (e.g., CPU 210) of the wireless device 100 may be mounted on one or more circuit boards 1300 which may be mounted within the body 120 of the enclosure 110. The body 120 and lid 130 may enclose the circuit boards 1300, battery 230, etc.

According to one embodiment, the wireless device 100 is made waterproof by the use of an injected moulded housing or enclosure 110 of adequate wall thickness combined with one or more O-ring bore seals between its body 120 and lid 130.

According to one embodiment, the power output of the wireless device 100 (i.e., of the transmitter 240) is approximately 1 Watt. According to another embodiment, the power output of the wireless device 100 is approximately 4 Watts. According to one embodiment, the wireless device 100 operates in simplex mode. According to another embodiment, the wireless device 100 operates in duplex mode.

According to one embodiment, a select/scroll button(s) 182 (see FIG. 19) may be provided and used to navigate and select items from a menu presented via the GUI 150 on the display screen 140. According to one embodiment, two select/scroll buttons 182 may be used. The first such button may be used to activate the GUI 150 and scroll through menu items presented on the display 140 and the second such button may be used to select or enter a selected menu item. According to one embodiment, the select/scroll button(s) 182 may also function as an on/off switch 270. The wireless device 100 may be turned on by pressing the select/scroll button(s) 182.

According to one embodiment, upon activation of the wireless device 100, the geographic position of the wireless device 100 obtained from the GPS receiver 260 is presented on the display 140 in degrees of longitude and latitude 150.

According to one embodiment, when the chat push-to-talk button 180 is pressed, the user may transmit voice communications on a first channel (e.g., a first VHF channel such as VHF Channel 68). Typically, this first channel would be used for non-emergency voice communications. An indicator light 195 may be associated with the operation of the chat push-to-talk button 180.

According to one embodiment, when the hailing push-to-talk button 181 is pressed, the user may transmit voice communications on a second channel (e.g., a second VHF channel such as VHF Channel 16). Typically, this second channel would be used for emergency voice communications. An indicator light 195 may be associated with the operation of the hailing push-to-talk button 181.

According to one embodiment, when the distress button 183 is pressed, the wireless device 100 transmits a DSC and/or AIS distress signal including geographic position of the wireless device 100 obtained from the GPS receiver 260 on a third channel (e.g., a third VHF channel such as VHF Channel 70) to, for example, dive and rescue boats or a central monitoring station. Typically, this third channel would be used for emergency non-voice communications. A pulsing strobe light 195 may be associated with the operation of the DSC and/or AIS button 183.

According to one embodiment, the antenna 190 is made of steel helicoil spring coated in rubber. According to one embodiment, the antenna 190 may retract into the body 120 through an opening formed in the lid 130 and hence may be contained within the enclosure 110. The antenna 190 may be extendible (e.g., using springs) to its upright operating position when the wireless device 100 is in use. According to one embodiment, the antenna 190 may be a flat, flexible antenna which may be contained in the body 120 of the radio 100 under the lid 130.

According to one embodiment, the enclosure 110 of the wireless device 100 may have a transparent (or translucent) body 120 and transparent (or translucent) lid 130. According to one embodiment, the display 140 is mounted on a circuit board 1300 within the body 120 such that it may be viewed through the transparent body 120 or a portion 121 thereof. According to one embodiment, the display 140 is mounted in the body 120 of the wireless device 100 and is made waterproof using a rubber membrane sealed into the outer surface of the body 120.

According to one embodiment, the wireless device 100 does not include a display 140 or a GUI 150. According to one embodiment, the enclosure 110 of the wireless device 100 may have an opaque body 120 and opaque lid 130. According to one embodiment, the enclosure 110 of the wireless device 100 may have an opaque body 120 and a transparent (or translucent) lid 130.

According to one embodiment, the wireless device 100 is provided with a solar panel for charging the battery 230 in addition to or in place of the USB interface 211. According to one embodiment, the battery 230 may be charged by induction. According to one embodiment, the wireless device 100 may receive and transmit status and programming information by BlueTooth™ communications in addition to or in place of the USB interface 211. According to one embodiment, the wireless device 100 includes a bearing function which displays the bearing (e.g., in degrees true, an arrow indication, etc.) of a second wireless device 100 on the display 140 of the wireless device 100 when the wireless device 100 receives a distress signal (e.g., a DCS and/or AIS distress signal) from the second wireless device 100.

Referring to FIGS. 1 and 2, according to one embodiment, to detect when the wireless device 100 has been submerged in water (or other fluid), the wireless device 100 includes a water pressure sensor 310 mounted on a front portion 361 (e.g., a recessed portion) of the outer surface 360 of the body 120 of the wireless device 100 near the bottom 370 of the device 100. The water pressure sensor 310 is enclosed by a sensor cap or cover 300. One or more openings 331 in the sensor cover 300 allow water to enter the volume or container 301 formed between the cover 300 and the portion 361 of the outer wall 360 of the device 100 and to come into contact with the water pressure sensor 310. The openings 331 may be arranged as a grill 330. The sensor cover 300 may be removable or fixed. According to one embodiment, the sensor cover 300 has an open back and top and snaps into place over the front portion 361 of the outer surface 360 of the body 120 of the wireless device 100.

The water pressure sensor 310 may be a finely tuned pressure switch. When water enters the container 301 and comes in contact with the water pressure sensor 310, the water pressure sensor 310 sends a signal (e.g., by contact closure) to the microprocessor 210 which may then cause the wireless device 100 to transmit an alarm message by radio to a central monitoring system indicating that the user of the wireless device 100 may be overboard or otherwise submerged in water (or other fluid). The man-overboard alarm message may be formatted according to DSC and/or AIS standards and may include the location of the wireless device 100 obtained from the GPS receiver 260.

The sensor cover 300 reduces false man-overboard alarm messages from being generated by reducing contact of the pressure sensor 310 with water that is splashed on the wireless device 100 from heavy seas or rain while the user is on board. In addition, a time delay may be included such that the pressure sensor 310 must detect the presence of water for a predetermined period of time before a man overboard alarm message is generated. A small drain hole 340 is provided in or near the bottom of the sensor cover 300 to allow rain or wave spray to drain from the container 301 to prevent water accumulation from these sources so that the generation of false man-overboard alarm messages may be further reduced.

Referring to FIGS. 3 and 4, according to one embodiment, rather than a water pressure sensor 310, a water level sensor 320 having first and second spaced contacts 321, 322 may be used to detect the presence of water in the container 301. When there is enough water in the container 301 to link the first and second contacts 321, 322 (i.e., short the two contacts 321, 322), the water level sensor 320 sends a signal (e.g., by contact closure) to the microprocessor 210 which may then cause the wireless device 100 to transmit an alarm message by radio to a central monitoring system indicating that the user of the wireless device 100 may be overboard or otherwise submerged in water (or other fluid). According to one embodiment, the first and second contacts 321, 322 may be separated by a predetermined distance (e.g., 25 millimetres). According to one embodiment, the first and second contacts 321, 322 may be horizontally disposed in the container 301 or on the portion 361 (e.g., the recessed portion) of the outer wall 360 of the body 120 of the wireless device 100.

Referring to FIGS. 5 and 6, according to one embodiment, the water level sensor 320 and sensor cover 300 may be mounted on a rear portion 362 (e.g., a recessed portion) of the outer wall 360 of the body 120 of the wireless device 100. Referring to FIGS. 7 and 8, according to one embodiment, the water pressure sensor 310 and sensor cover 300 may be mounted on a rear portion 362 (e.g., a recessed portion) of the outer wall 360 of the body 120 of the wireless device 100.

Mounting the water pressure or level sensor 310, 320 and the sensor cover 300 on the rear of the wireless device 100 may further reduce false man-overboard alarm messages from being generated by reducing contact of the water pressure or level sensor 310, 320 with water that is splashed onto the wireless device 100 from heavy seas or rain while the user is on board.

Referring to FIGS. 23 to 30, rather than the sensor cover 300 having one or more openings 331 arranged as a grill 330, the sensor cover 300 may include a single opening 351 covered by a water intake flap 350. The flap 350 may be provided with a stainless steel spring with very fine (low) loading to control its opening and closing. When the wireless device 100 is submerged in water, water pressure acting on the flap 350 overcomes the spring and causes the flap 350 to open (i.e., swing inwardly) and allows water to enter the container 301. However, the spring keeps the flap 350 closed when the wireless device 100 is not submerged in water hence reducing false man-overboard alarm messages from being generated by reducing contact of the water pressure or level sensor 310, 320 with water that is splashed onto the wireless device 100 from heavy seas or rain while the user is on board.

Referring to FIGS. 9 to 18, according to one embodiment, to detect when the wireless device 100 has been submerged in water (or other fluid), the wireless device 100 includes a water pressure sensor 310 mounted in a tube 400 provided within the body 120 of the wireless device 100. The tube 400 may be disposed substantially vertically or downwardly inclined within the body 120 of the wireless device 100. A valve or opening 401 that may be located in the cover 130 of the wireless device 100 allows water to enter the top 405 of the tube 400, to flow down the tube 400, and to come into contact with the water pressure sensor 310 mounted at or near the bottom 402 of the tube 400. According to one embodiment, a water level sensor 320 may be used instead of a water pressure sensor 310.

When water enters the tube 400 and comes into contact with the water pressure sensor 310, the water pressure sensor 310 sends a signal (e.g., by contact closure) to the microprocessor 210 which may then cause the wireless device 100 to transmit an alarm message by radio to a central monitoring system indicating that the user of the wireless device 100 may be overboard or otherwise submerged in water (or other fluid). The man-overboard alarm message may be formatted according to DSC and/or AIS standards and may include the location of the wireless device 100 obtained from the GPS receiver 260.

The tube 400 reduces false man-overboard alarm messages from being generated by reducing contact of the water pressure sensor 310 with water that is splashed onto the wireless device 100 from heavy seas or rain while the user is on board. In addition, a time delay may be included such that the water pressure sensor 310 must detect the presence of water for a predetermined period of time before a man overboard alarm message is generated. A small drain hole 403 is provided at or near the bottom 402 of the tube 400 to allow rain or wave spray to drain from the tube 400 in order to prevent water accumulation from these sources so that the generation of false man-overboard alarm messages may be further reduced.

Referring to FIGS. 19 to 22, rather than a single tube 400, the wireless device 100 may be provided with two tubes each having a respective valve or opening 410, 420, drain hole 413, 423, and water pressure or level sensor 310, 320. The valve or openings 410, 420 for the tubes may be disposed on opposite sides (e.g., the front and rear sides) of the wireless device 100.

Thus, according to one embodiment, there is provided a wireless device 100, comprising: a body 120; a transmitter 240 and a receiver 230 mounted in the body 120 and adapted for at least two-way wireless voice and data communications; a sensor 310, 320 mounted in a container 301, 400 formed on or within the body 120, the sensor 310, 320 generating a signal when liquid entering the container 301, 400 accumulates to a predetermined level or volume; and, a processor adapted to receive the signal and to control the transmitter 240 to transmit an alarm message indicative of the signal.

In the above wireless device 100, the container 301, 400 may have an opening 331, 351, 401 formed therein, the opening 331, 351, 401 sized to allow entry of the liquid into the container 301, 400 at a predetermined rate when the wireless device 100 is submerged in the liquid. The opening 331, 351, 401 may be a grill 330. The opening 331, 351, 401 may be covered by a water pressure activated flap 350. The wireless device 100 may further include a drain hole 340, 403 formed in the container 301, 400, the drain hole 340, 403 sized to allow the liquid to drain from the container 301, 400 at a predetermined rate. The container 301, 400 may be an inclined tube 400 disposed within the body 120. The liquid may be water. The sensor 310, 320 may be one of a water pressure sensor 310 and a water level sensor 320. The alarm message may be a man-overboard alarm message and may be transmitted to a central monitoring station. And, the wireless device 100 may further include a display 140 mounted on or in an outer surface 360 of the body 120 for displaying a function, status, or location of the wireless device 100.

The above embodiments may contribute to an improved wireless device 100 and may provide one or more advantages. First, the cover 300 provided for the water pressure or water level sensor 310, 320 may reduce the generation of false man-overboard alarm messages. Second, the use of an enclosed tube 400 in which the water pressure or water level sensor 310, 320 is mounted may reduce the generation of false man-overboard alarm messages. Third, the cover 300 and enclosed tube 400 provide protection from the elements, especially water spray, which contributes to improved reliability, less maintenance, and a longer service life.

The embodiments of the disclosure described above are intended to be exemplary only. Those skilled in this art will understand that various modifications of detail may be made to these embodiments, all of which come within the scope of the disclosure.

1. A wireless device, comprising:
a body;
a transmitter and a receiver mounted in the body and adapted for at least two-way wireless voice and data communications;
a sensor mounted in a container formed on or within the body, the sensor generating a signal when liquid entering the container accumulates to a predetermined level or volume; and,
a processor adapted to receive the signal and to control the transmitter to transmit an alarm message indicative of the signal.

2. The wireless device of claim 1 wherein the container has an opening formed therein, the opening sized to allow entry of the liquid into the container at a predetermined rate when the wireless device is submerged in the liquid.

3. The wireless device of claim 2 wherein the opening is a grill.

4. The wireless device of claim 2 wherein the opening is covered by a water pressure activated flap.

5. The wireless device of claim 2 and further comprising a drain hole formed in the container, the drain hole sized to allow the liquid to drain from the container at a predetermined rate.

6. The wireless device of claim 1 wherein the container is an included tube disposed within the body.

7. The wireless device of claim 1 wherein the liquid is water.

8. The wireless device of claim 7 wherein the sensor is one of a water pressure sensor and a water level sensor.

9. The wireless device of claim 7 wherein the alarm message is a man-overboard alarm message and is transmitted to a central monitoring station.

10. The wireless device of claim 1 and further comprising a display mounted on or in an outer surface of the body for displaying a function, status, or location of the wireless device.
